(19) United States
(12) Patent Application Publication
(10) Pub. No.: US 2026/0009193 A1
(43) Pub. Date: Jan. 8, 2026

(54) VEHICLE-MOUNTED ATTENUATOR

(71) Applicant: Lindsay Transportation Solutions, LLC, Omaha, NE (US)

(72) Inventors: Nick Bang, Omaha, NE (US); Marco Anghileri, Omaha, NE (US); Daniel Kronberg, Omaha, NE (US)

(21) Appl. No.: 19/243,210

(22) Filed: Jun. 19, 2025

Related U.S. Application Data
(60) Provisional application No. 63/666,720, filed on Jul. 2, 2024.

(51) Int. Cl. E01F 15/14; B60R 19/00; B60R 19/18

(52) U.S. Cl. CPC E01F 15/148; B60R 19/18; B60R 2019/005

(57) ABSTRACT

A vehicle-mounted impact attenuator assembly that can be removably attached to a truck or other support vehicle and then driven to a roadway work zone or other area where road repair equipment and/or workers are operating includes a plurality of support plates or bulkheads; a plurality of energy absorption modules sandwiched between and attached to the support plates or bulkheads; and a mount for mounting the attenuator to a support vehicle. When the impact attenuator assembly is struck by an impacting vehicle, the support plates or bulkheads are pushed together toward the support vehicle, compressing the energy absorption modules to absorb the impact forces.

### CROSS-REFERENCE TO RELATED APPLICATION

The current patent application is a non-provisional utility patent application which claims priority benefit, with regard to all common subject matter, of earlier-filed U.S. Provisional Application Ser. No. 63/666,720; titled “VEHICLE-MOUNTED ATTENUATOR”; and filed Jul. 2, 2024. The Provisional Application is hereby incorporated by reference, in its entirety, into the current patent application.

### BACKGROUND

Crash cushions, also known as impact attenuators or crash barriers, absorb and reduce impact forces when vehicles collide with guardrails, bridge supports, roadside barriers, and other fixed objects on or near roadways. They are typically placed in locations where there is a high risk of vehicle crashes, such as highway exits, intersections, or construction zones and minimize the severity of collisions by providing a controlled deceleration path for vehicles, thereby reducing the likelihood of injury to vehicle occupants and damage to the impacting vehicles and the objects protected by the crash cushions.

Conventional crash cushions are not easily moved and installed and are therefore not suitable for protecting moveable objects such as road repair equipment and the people operating such equipment. For protecting such moveable equipment and people, vehicle-mounted attenuators are often used. Vehicle-mounted attenuators are typically mounted to the backs of dump trucks, flat-bed trucks, or other surrogate vehicles that are parked or slowly driven at the oncoming traffic end of roadway work zones to provide protection to the work zones and any impacting vehicles.

Unfortunately, known vehicle-mounted attenuators suffer from several disadvantages that limit their utility. For example, existing vehicle-mounted attenuators have inconsistent deformation profiles that cascade with stronger impacts. Additionally, they are often large and bulky, which makes it difficult to move and position them properly and to store them when not in use. When mounted on truck beds, they also inhibit use of the truck beds for hauling other objects.

The background discussion is intended to provide information related to the present invention which is not necessarily prior art.

### SUMMARY

The present invention solves the above-described problems and related problems by providing an improved vehicle-mounted impact attenuator assembly that exhibits superior deformation properties, is easier to mount, maneuver, and store, and does not unduly limit the normal use of the vehicle to which it is mounted.

A vehicle-mounted attenuator constructed according to an embodiment of the invention can be removably attached to a truck or other support vehicle. The support vehicle can then be driven to or otherwise positioned near a roadway work zone or other area where road repair equipment and/or workers are operating. If struck by an impacting vehicle, the attenuator crushes in a coordinated fashion toward the support vehicle to dissipate impact forces from the impacting vehicle.

One embodiment of the attenuator broadly includes a plurality of support plates; a plurality of energy absorption modules sandwiched between and attached to the support plates; and a mount for mounting the attenuator to a support vehicle.

The support plates are formed of aluminum sheet metal or other suitable rigid materials and are spaced apart along a longitudinal axis of the attenuator. Each support plate occupies a vertical plane that extends along an axis perpendicular to the longitudinal axis. The attenuator may include any number of support plates.

The energy absorption modules are sandwiched between pairs of the support plates and are designed to crush in a coordinated fashion when an impacting vehicle strikes the attenuator and pushes the support plates towards the support vehicle. In one embodiment, three of the energy absorption modules are sandwiched between each adjacent pair of support plates, but the attenuator may include any number of energy absorption modules.

In one embodiment, the energy absorption modules are formed of aluminum sheet metal or other suitable rigid materials and each comprises first and second longitudinally extending plates and a first laterally extending plate. The longitudinally extending plates, which extend along an axis parallel to the longitudinal axis of the attenuator and which are spaced apart about an axis transverse to the longitudinal axis, are positioned between and attached to two of the support plates. The two longitudinally extending plates include opposing outwardly protruding hinge sections.

The laterally extending plate, which extends along an axis perpendicular to the longitudinal axis of the attenuator, is positioned between and attached to the two longitudinally extending plates. The laterally extending plate also has a hinge section.

When the impact attenuator assembly is struck by an impacting vehicle, the support plates are pushed together toward the support vehicle, compressing the energy absorption modules to absorb the impact forces. As each energy absorption module is compressed, its longitudinally extending plates compress about their hinge sections and its laterally extending plate stretches about its hinge section to moderate the compression of the longitudinally extending plates. The laterally extending plate also provides a limit to the compression of the longitudinally extending plates before additional hinges in the longitudinal extending plates are activated or created through buckling. The compression of the longitudinally extending plates and the stretching of the laterally extending plate provide a controlled attenuation of the collision forces from the impacting vehicle.

In other embodiments, each energy absorption module further comprises a second laterally extending plate positioned between and attached to the longitudinally extending plates. In yet other embodiments, each energy absorption module may further comprise a third laterally extending plate positioned between and attached to the longitudinally extending plates.

A vehicle-mounted attenuator assembly constructed according to another embodiment of the invention includes several attenuator sections attached end-to-end. In one embodiment, the attenuator assembly includes a first attenuator section attached directly or indirectly to a support vehicle and a second attenuator section at the impact end of the attenuator. The first attenuator section is pivotally connected to the support vehicle with a first pivot mount, and the first and second attenuator sections are pivotally connected to one another via a second pivot mount. The attenuator assembly further comprises an actuator for pivoting the first attenuator section about the first pivot mount and pivoting the second attenuator section about the second pivot mount to raise and stack the attenuator sections for easier transport and storage.

A vehicle-mounted impact attenuator assembly constructed according to another embodiment of the invention comprises a plurality of longitudinally spaced bulkheads and a number of vertically extending energy absorption modules and horizontally extending energy absorption modules sandwiched between the bulkheads.

Each vertically-extending energy absorption module comprises first and second vertically and longitudinally extending plates positioned between a pair of the bulkheads, with each having a hinge section. The vertically-extending energy absorption module also comprises a vertically and laterally extending plate positioned between and attached to or near the hinges of the vertically and longitudinally extending plates. The vertically and laterally extending plate also has a hinge section.

The horizontally-extending energy absorption modules are similar to the vertically-extending energy absorption modules except they are shifted 90 degrees. Each horizontally-extending energy absorption module comprises first and second horizontally and longitudinally extending plates positioned between the bulkheads, each having a hinge section. The horizontally-extending energy absorption module also comprises a vertically and laterally extending plate positioned between and attached to or near the hinges of the horizontally and longitudinally extending plates, the vertically and laterally extending plate also having a hinge section.

If the impact attenuator assembly is struck by an impacting vehicle, the bulkheads are pushed together toward the support vehicle, compressing the energy absorption modules to absorb the impact forces. As each energy absorption module is compressed, its longitudinally extending plates compress about their hinge sections and its laterally extending plate stretches about its hinge section to moderate the compression of the longitudinally extending plates.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### DRAWING DESCRIPTION

Embodiments of the present invention are described in detail below with reference to the attached drawing figures. The drawing figures do not limit the present invention to the specific embodiments disclosed and described herein. The drawings are not necessarily to scale, emphasis instead being placed upon clearly illustrating the principles of the invention.

FIG. 1 is a perspective view of a vehicle-mounted impact attenuator assembly constructed in accordance with a embodiment of the present invention.

FIG. 2 is a top view of the impact attenuator assembly of FIG. 1.

FIG. 3 is a fragmentary side perspective view of the impact attenuator assembly of FIG. 1.

FIG. 4 is a fragmentary front perspective view of the impact attenuator assembly of FIG. 1.

FIG. 5 is a perspective view of an energy absorption module constructed in accordance with an embodiment of the present invention that may be installed in the impact attenuator assembly of FIG. 1 and other embodiments of the invention.

FIG. 6 is a top view of the energy absorption module of FIG. 5.

FIG. 7 is a top view of an energy absorption module constructed in accordance with another embodiment of the present invention.

FIG. 8 is a top view of an energy absorption module constructed in accordance with yet another embodiment of the present invention.

FIG. 9 is a side view of a vehicle-mounted impact attenuator assembly constructed in accordance with another embodiment of the present invention and shown in its fully extended position.

FIG. 10 is a fragmentary side view of the impact attenuator assembly of FIG. 9.

FIG. 11 is a side view of the impact attenuator assembly of FIG. 9 shown between its fully extended and folded positions.

FIG. 12 is a fragmentary side view of the impact attenuator assembly of FIG. 9.

FIG. 13 is a side view of the impact attenuator assembly of FIG. 9 shown in its fully folded position.

FIG. 14 is a fragmentary side view of the impact attenuator assembly in its fully folded position.

FIG. 15 is a side view of a vehicle-mounted impact attenuator assembly constructed in accordance with another embodiment of the present invention and shown in its fully extended position.

FIG. 16 is a side view of the impact attenuator assembly of FIG. 15 shown in its fully retracted position.

FIG. 17 is a perspective view of a vehicle-mounted impact attenuator assembly constructed in accordance with another embodiment of the present invention.

FIG. 18 is a perspective view of a vehicle-mounted impact attenuator assembly constructed in accordance with yet another embodiment of the present invention.

FIG. 19 is another perspective view of the impact attenuator assembly of FIG. 18.

FIG. 20 is a bottom perspective view of the impact attenuator assembly of FIG. 18.

FIG. 21 is another bottom perspective view of the impact attenuator assembly of FIG. 18.

FIG. 22 is a perspective view of a nose bulkhead of the impact attenuator assembly of FIG. 18.

FIG. 23 is a sectional view of the nose bulkhead taken along line 23/23 of FIG. 22.

FIG. 24 is a perspective view of a front bulkhead of the impact attenuator assembly of FIG. 18.

FIG. 25 is a perspective view of a rear bulkhead of the impact attenuator assembly of FIG. 18.

FIG. 26 is a photograph of an impact attenuator assembly constructed in accordance with any of the embodiments of the present invention shown in a crushed and compressed state after being struck by an impacting vehicle.

### DETAILED DESCRIPTION

Vehicle-mounted impact attenuator assemblies constructed in accordance with embodiments of the present invention will now be described in more detail with reference to the attached drawing figures. The impact attenuator assemblies exhibit superior deformation properties; are easier to mount to support vehicles, maneuver, and store; and do not unduly limit the normal use of the support vehicles to which they are mounted.

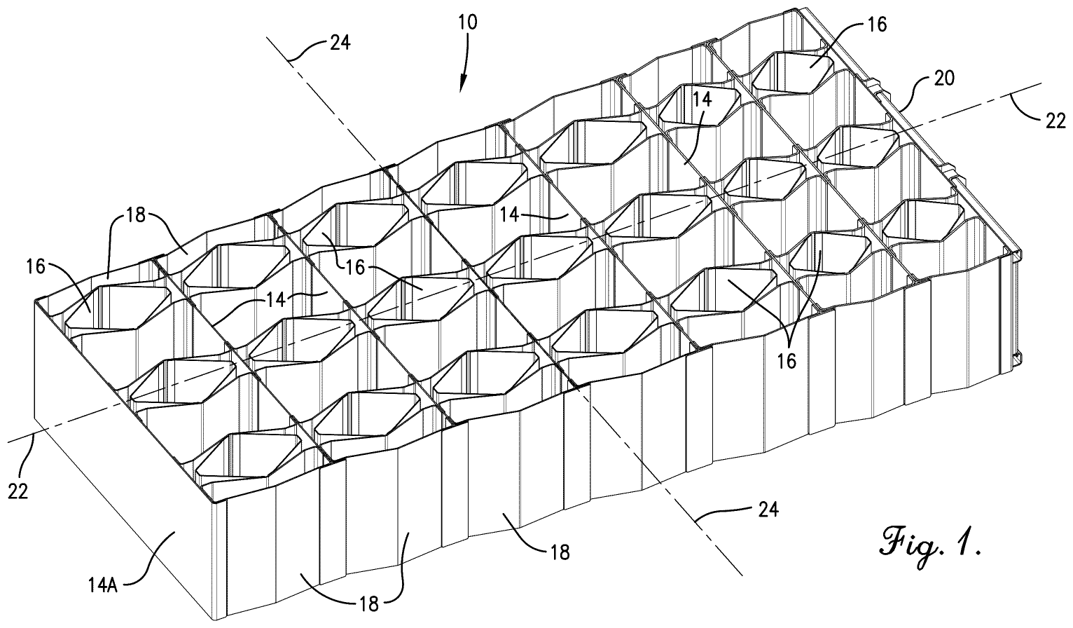

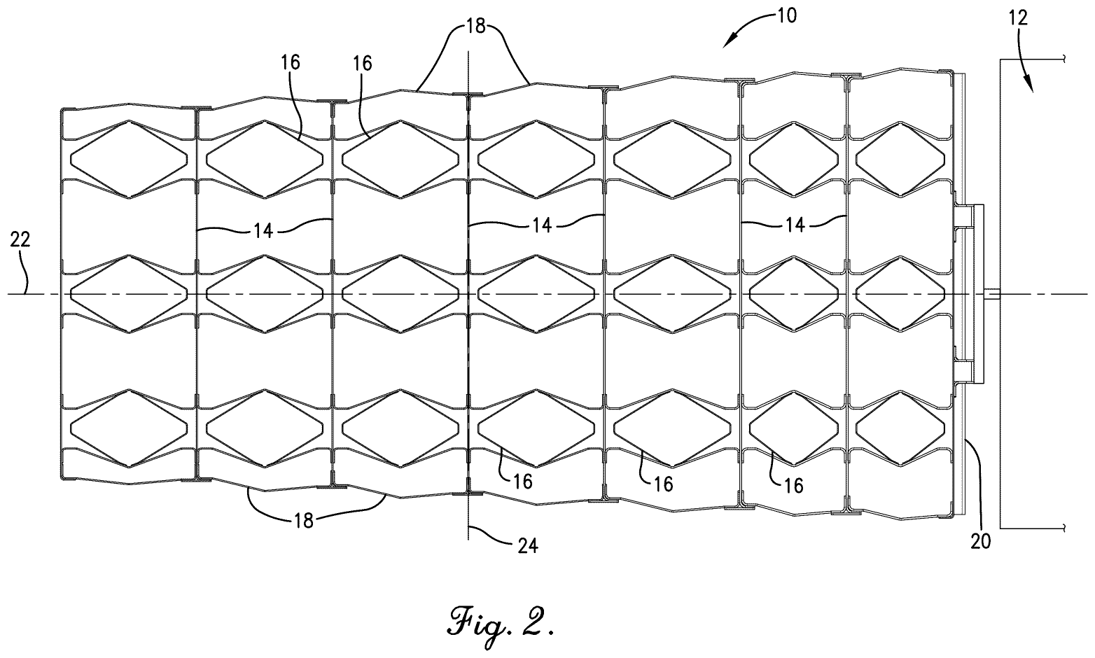

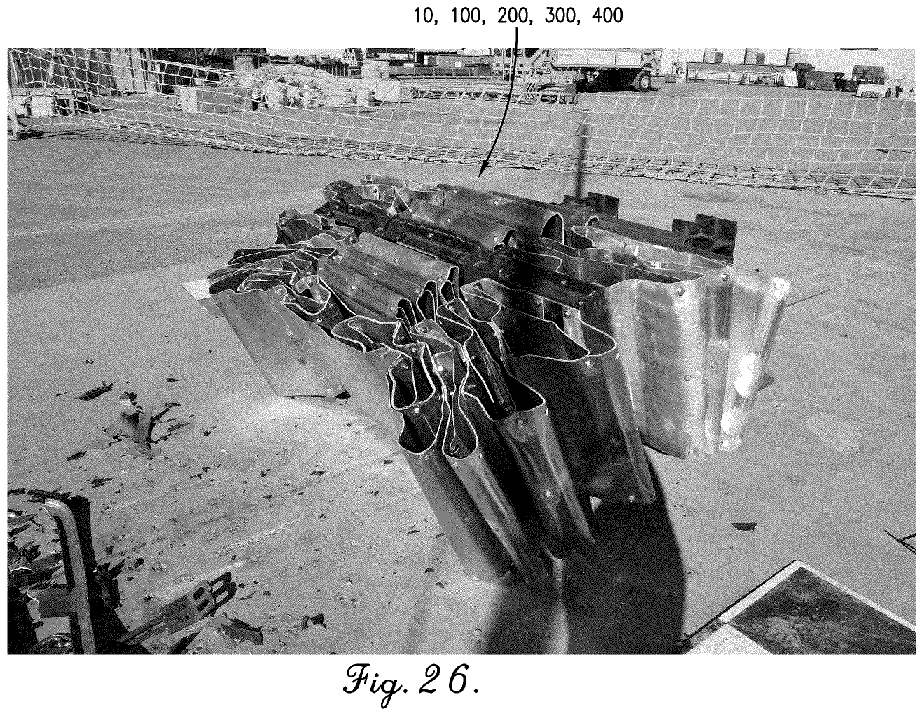

A vehicle-mounted impact attenuator assembly 10 constructed according to one embodiment of the invention is shown in FIGS. 1-6. As depicted in FIG. 2, the impact attenuator assembly 10 can be removably attached to the back of a truck or other support vehicle 12. The support vehicle 12 can then be driven to or otherwise positioned near a roadway work zone or other area where road repair equipment and/or workers are operating. As depicted in FIG. 26 and described in more detail below, the impact attenuator assembly 10 crushes in a coordinated fashion toward the support vehicle 12 when struck by an impacting vehicle to dissipate impact forces from the impacting vehicle.

As best shown in FIG. 1, the impact attenuator assembly 10 broadly includes a plurality of support plates 14; a plurality of energy absorption modules 16 sandwiched between and attached to the support plates; a plurality of side panels 18 interconnecting the support plates and enveloping the energy absorption modules 16; and a backup mount 20 for mounting the impact attenuator assembly to the support vehicle 12.

The support plates 14 are spaced apart along a longitudinal axis 22 of the attenuator. In one embodiment, each support plate is rectangular and occupies a vertical plane parallel to an axis 24 that is transverse to the longitudinal axis 22. The support plate on the impact end of the attenuator forms a nose plate 14A, and the support plate on the opposite end of the attenuator supports the backup mount 20. The attenuator 10 may include any number of support plates 14 to support any number of energy absorption modules 16 so that the attenuator 10 may be designed to absorb any amount of impact forces. In one embodiment, the support plates 14 are formed of aluminum sheet metal or other suitable rigid materials and are approx. 2-6 feet long, 2-4 feet tall, and ⅛-½ inches thick.

The energy absorption modules 16 are positioned between the support plates and provide the primary impact absorption properties of the attenuator. As best seen in FIG. 2, several of the energy absorption modules 16 are sandwiched between each adjacent pair of support plates 14. In one embodiment, three of the modules 16 are supported between each adjacent pair of support plates, but the impact attenuator assembly 10 may include any total number of the modules 16 and any number of them between each pair of support plates.

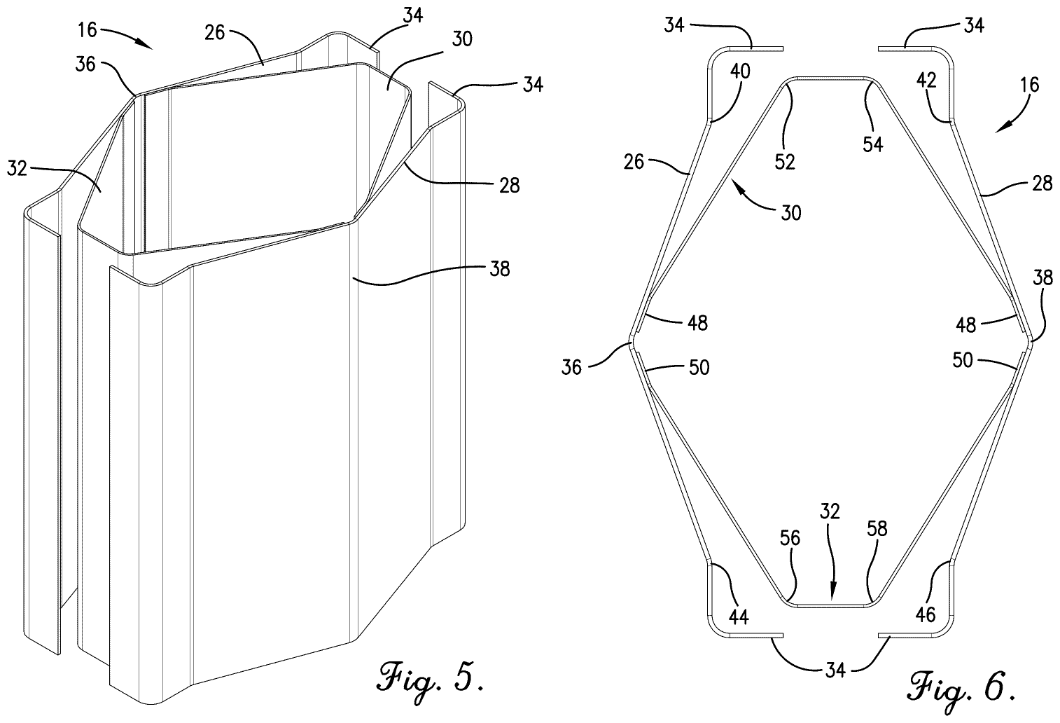

A single energy absorption module 16 constructed in accordance with an embodiment of the invention is shown removed from the attenuator in FIGS. 5 and 6. The exemplary energy absorption module comprises first and second longitudinally extending plates 26, 28 and first and second laterally extending plates 30, 32. The plates 26, 28, 30, 32 may be formed of aluminum sheet metal or other suitable rigid materials.

The longitudinally extending plates 26, 28 extend generally parallel to the longitudinal axis 22 of the attenuator assembly and include bent end sections 34 that are welded to or otherwise attached to a pair of the support plates 14. The longitudinally extending plates also include opposed outwardly protruding hinge sections 36,38 and opposed inwardly protruding hinge sections 40, 42 and 44, 46.

The laterally extending plates 30, 32 are positioned between and attached to the longitudinally extending plates 26, 28. The plates 30, 32 include angled end sections 48, 50 that are welded to or otherwise attached near the mid-point of each longitudinally extending plate 26, 28 so as not to interfere with the movement of the hinge sections 36, 38, 40, 42, 44, 46. Each laterally extending plate has a pair of hinge sections 52, 54 and 56, 58. Resistance to the deformation of the longitudinal plates 26, 28 is increased by the lateral plates 30, 32 being stretched and straightened about their hinges, keeping the overall force resistance of the energy absorption module consistent as it is deformed.

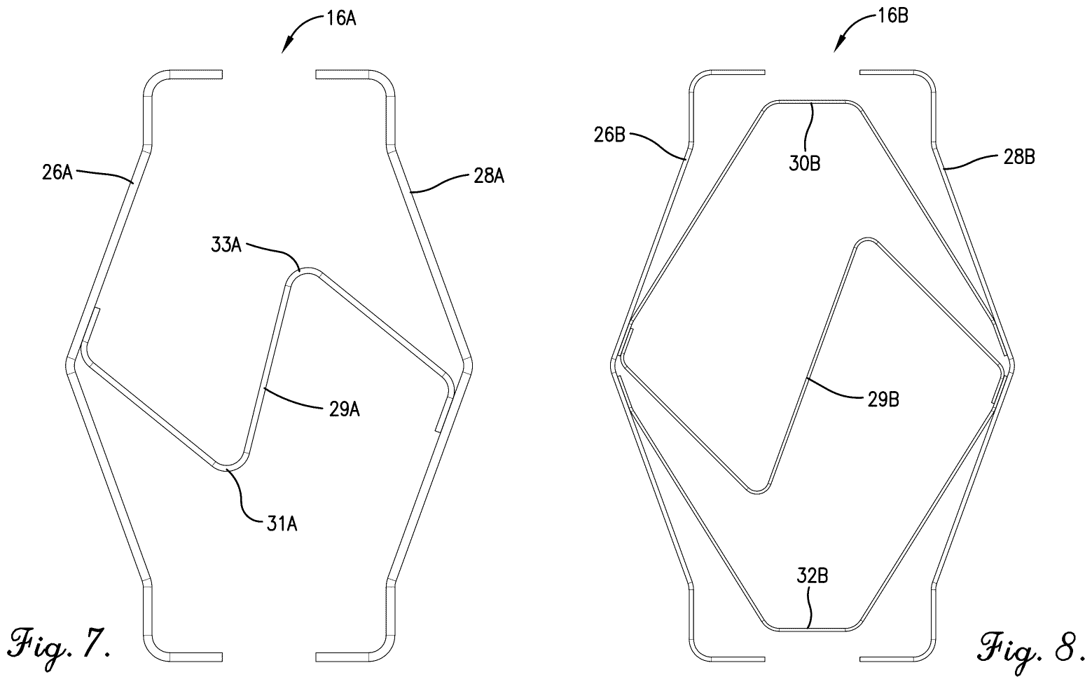

FIG. 7 depicts an energy absorption module 16A according to another embodiment of the invention. The exemplary energy absorption module 16A comprises first and second longitudinally extending plates 26A, 28A that are substantially identical to the longitudinally extending plates 26, 28 described above. Instead of two lateral plates, the module 16A has a single lateral plate 29A attached to opposite, diagonal sides of the longitudinal plates 26A, 28A. The lateral plate has bends 31A, 33A. Resistance to the deformation of the longitudinal plates 26A, 28A is increased by the lateral plate 29A being stretched and straightened about the hinges 31A, 33A, keeping the overall force resistance of the energy absorption module consistent as it is deformed.

FIG. 8 depicts an energy absorption module 16B according to another embodiment of the invention. The exemplary energy absorption module 16B comprises first and second longitudinally extending plates 26BA, 28B that are substantially identical to the longitudinally extending plates 26, 28 described above. The module 16B also includes two lateral plates 30B, 32B substantially identical to the plates 30, 32 of the embodiment shown in FIGS. 5 and 6 and a third lateral plate 29B substantially identical to the plate 29A of embodiment shown in FIG. 7. Resistance to the deformation of the longitudinal plates is increased by the lateral plates being stretched and straightened about their hinges.

The above-described energy absorption modules 16, 16A, 16B are just exemplary embodiments of energy absorption modules that may be used in the attenuator assembly 10 and may be replaced with other embodiments. Moreover, the plate lengths, lengths between bends, bend angles, material thickness, material type, and connections of the energy absorption modules 16, 16A, 16B and other embodiments of the modules can be modified to obtain desired overall force resistances and behaviors.

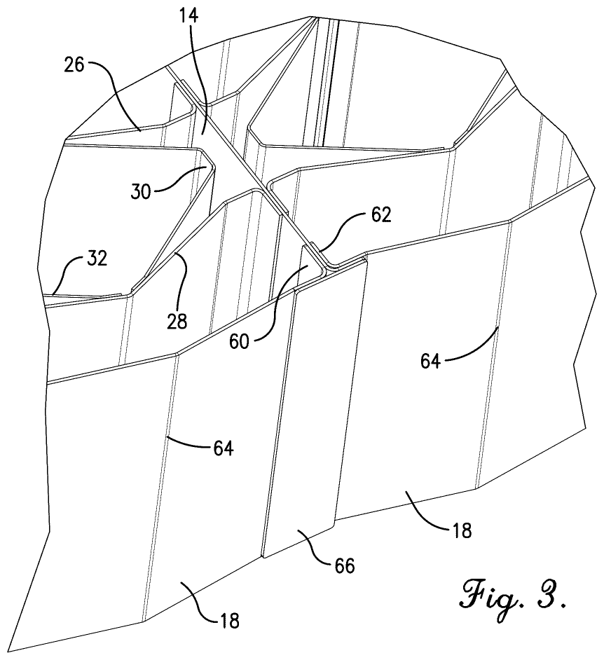

The side panels 18, which are best shown in FIGS. 1 and 3, interconnect the support plates 14 and envelope the energy absorption modules 16. As best shown in FIG. 3, each side panel has a pair of connection flanges 60, 62 that are welded or otherwise attached to one of the support plates 14 and an outwardly protruding hinge 64. The ends of adjacent side panels 18 may be covered by an end panel 66.

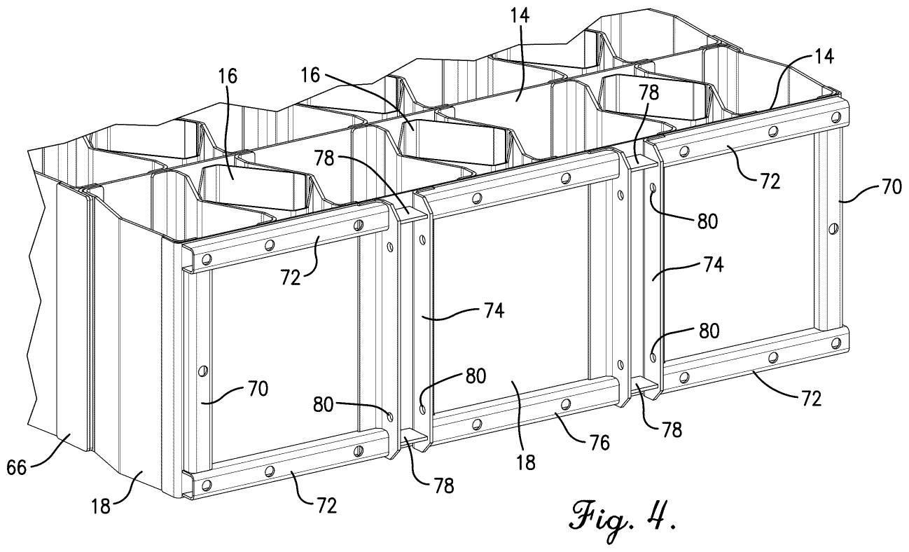

The backup mount 20 is on the support vehicle 12 side of the attenuator assembly and provides a mounting surface for mounting the attenuator assembly to the support vehicle 12. As best shown in FIG. 4, an embodiment of the backup mount includes two outer c-channels 70 that extend vertically along one of the support plates 14, c-channels 72 that extend horizontally along the plate on each end of the vertically extending c-channels, two pairs of horizontally spaced mounting angles 74 that extend vertically along the plate and connected to the horizontal c-channels, and two c-channels 76 extending between the mounting angle pairs. Each mounting angle pair 74 includes support plates 78 extending therebetween at each end of the angles. The mounting angles have a plurality of mounting holes 80 formed therein. Which can receive fasteners to attach the backup mount 20 to a vehicle mount.

In use, the impact attenuator assembly 10 is attached to the rear of the support vehicle with the backup mount 20 and any type of vehicle mount. The support vehicle 12 is then driven to or otherwise positioned near a roadway work zone or other area where road repair equipment and/or workers are operating. If struck by an impacting vehicle, the impact attenuator assembly 10 crushes in a coordinated fashion toward the support vehicle to dissipate impact forces from the impacting vehicle. When struck, the support plates 14 are pushed together toward the support vehicle, compressing the energy absorption modules 16 to absorb the impact forces.

As each energy absorption module 16 is compressed, its longitudinally extending plates 26, 28 compress about their hinge sections 36, 38, 40, 42, 44, 46 and its laterally extending plate or plates 30, 32 stretch about their hinge sections 52, 54, 56, 58 to moderate the compression of the longitudinally extending plates. The laterally extending plate also provides a limit to the compression of the longitudinally extending plates before additional hinges in the longitudinal extending plates are activated or created through buckling.

As the longitudinal plates 26, 28 deform during an impact, the force required to continue deformation gradually decreases as the hinge angles increase. The lateral plates 30, 32 provide an inverse deformation profile-as the longitudinal plates 26, 28 decrease in resistance to deformation, the lateral plates 30, 32 increase in resistance to deformation, thus providing additional strength to the longitudinal plates. The longitudinal and lateral plates work together to create a more consistent energy absorption force profile. A more consistent force profile is advantageous to an efficient overall crash attenuator device as the overall length, amount of material and labor, and overall cost can be reduced. The side panels 18 also compress about their hinges 64 during impacts to provide further force dissipation.

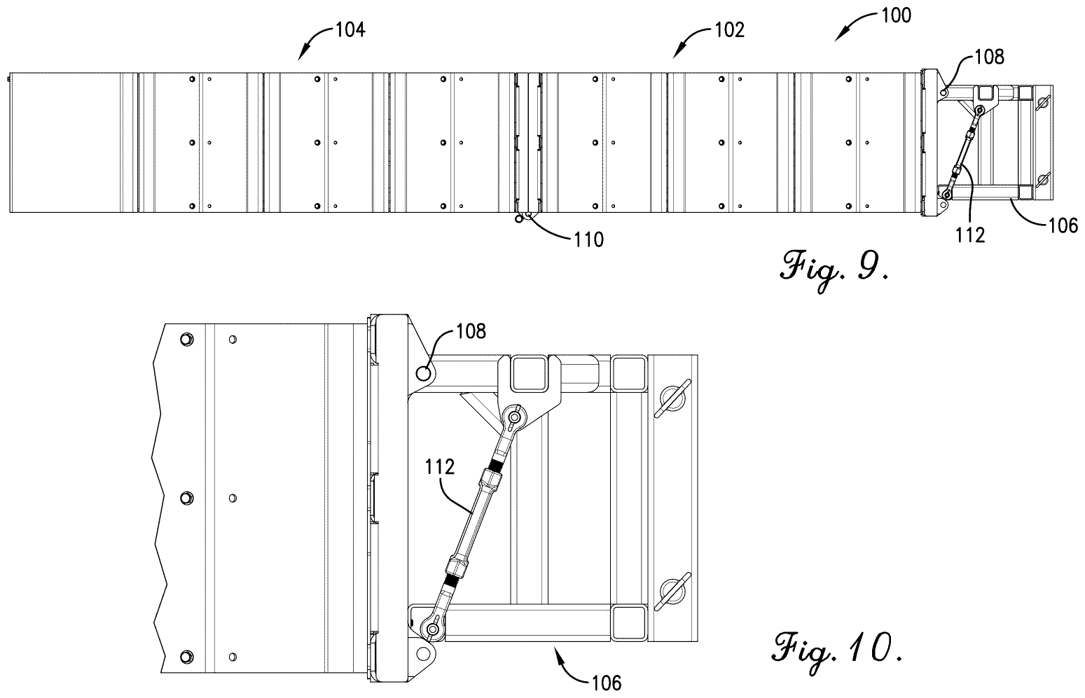

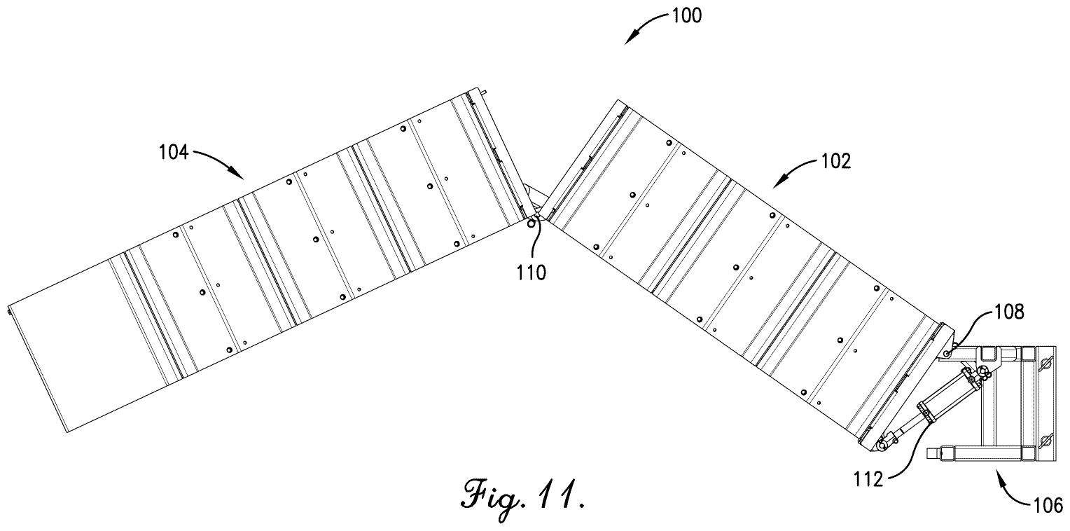

A vehicle-mounted impact attenuator assembly 100 constructed in accordance with another embodiment of the invention is depicted in FIGS. 9-14. The impact attenuator assembly 100 includes several attenuator sections attached end-to-end that can be folded and/or retracted for easier transport and storage. The impact attenuator assembly 100 may include any number of sections, and in one embodiment, includes a first attenuator section 102 mounted to its support vehicle and a second attenuator section 104 at the impact end of the attenuator.

The first attenuator section 102 may be the same or similar to the impact attenuator assembly 10 shown in FIGS. 1-8 and described above. Thus, the first attenuator section 102 may include a plurality of support plates; a plurality of energy absorption modules sandwiched between and attached to the support plates; a plurality of side panels interconnecting the supports and enveloping the energy absorption modules; and a backup mount for mounting the impact attenuator assembly to a support vehicle. Because these components are described in detail above, they will not be described again in connection with the embodiments of FIGS. 9-14.

The second attenuator section 104 is positioned on the end of the attenuator assembly 100 nearest an impacting vehicle and may also be the same or similar to the impact attenuator assembly 10 shown in FIGS. 1-8 and described above. Thus, the second attenuator section 104 may include a plurality of support plates; a plurality of energy absorption modules sandwiched between and attached to the support plates; a plurality of side panels interconnecting the supports and enveloping the energy absorption modules; and a backup mount for mounting the section 104 to the section 102. Because these components are described in detail above, they will not be described again in connection with the embodiments of FIGS. 9-14.

The impact attenuator assembly 100 further comprises a transition assembly 106 for supporting the first attenuator section 102 to the support vehicle. The transition assembly spaces the first attenuator section from the support vehicle so that it may be moved relative to the support vehicle and also provides a mounting location for components described below. An embodiment of the transition assembly 100 has a frame consisting of several horizontal and vertical tubes or bars that absorb impact forces and distribute them evenly across the width of the transition assembly. This shields the actuator descried below from damage during impacts.

The impact attenuator assembly 100 further comprises a first pivot mount 108 pivotally connecting the first attenuator section 102 to the transition assembly 106 and thus to the support vehicle; a second pivot mount 110 pivotally connecting the second attenuator section 104 to the first attenuator section 102; and an actuator 112 for pivoting the first attenuator section 102 about the first pivot mount 108 and pivoting the second attenuator section 104 about the second pivot mount 110 to raise and stack the attenuator sections for easier transport and storage.

The first pivot mount 108 may comprise a sleeve bearing and pivot pin or any other hinge mechanism that allows the first attenuator section 102 to be pivoted relative to the transition assembly.

The second pivot mount 110 may comprise a 180-degree hinge that pivotally connects the second attenuator section 104 to the first attenuator section 102. The hinge may include one hinge plate connected to the section 102 and another hinge plate connected to the section 104 with a hinge pin or other mechanism inserted into the hinge plates.

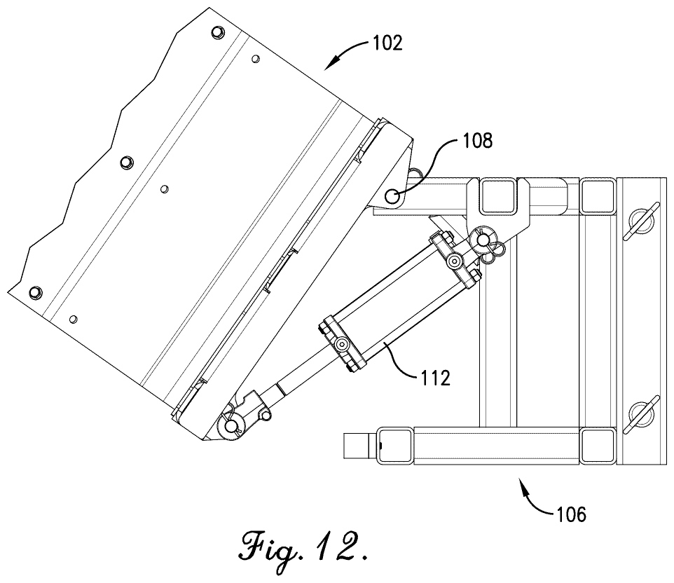

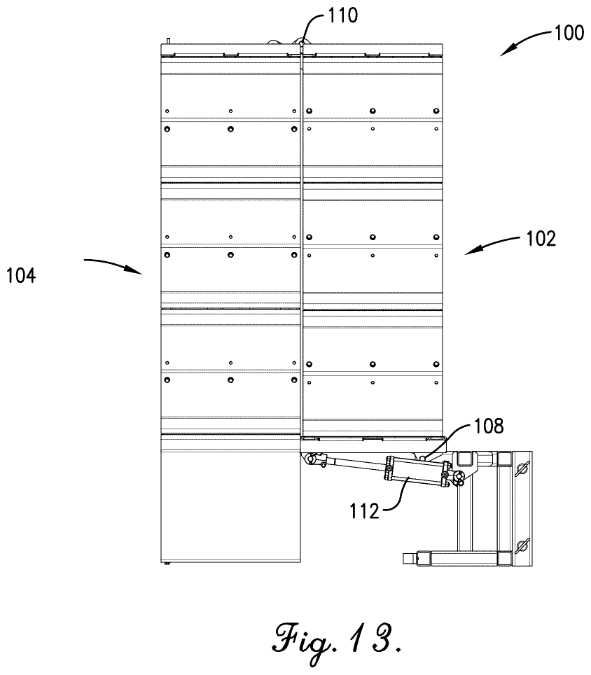

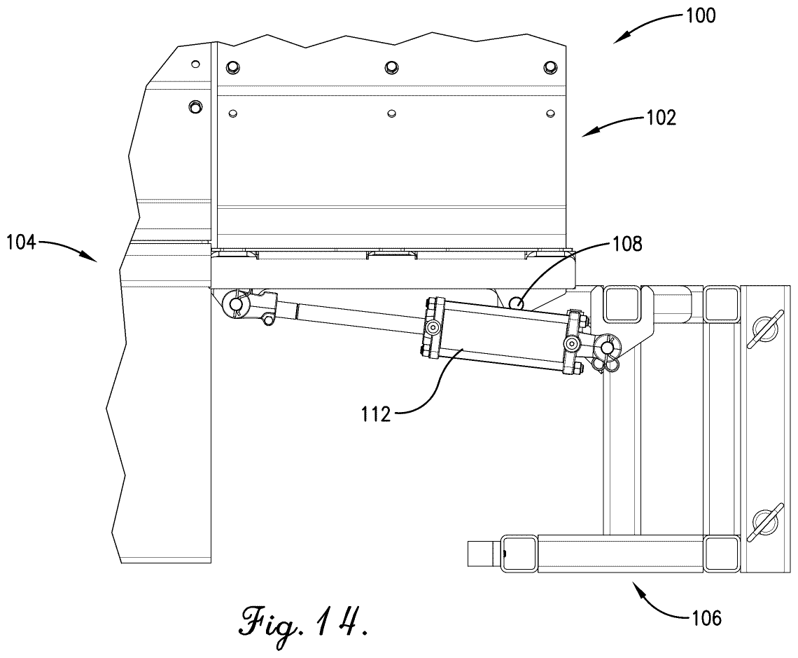

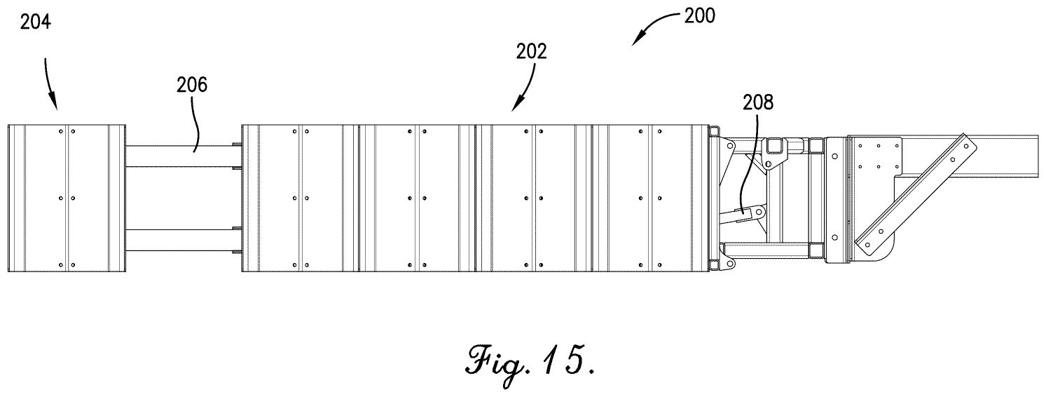

The actuator 112 pivots the first attenuator section 102 about the first pivot mount 108 and pivots the second attenuator section 104 about the second pivot mount 110 to shift the impact attenuator assembly 100 between its fully extended position or state shown in FIG. 9 and its raised and folded position shown in FIGS. 13 and 14, with intermediate positions shown in FIGS. 11 and 12. As illustrated in FIGS. 11-14, an embodiment of the actuator 112 is a hydraulic cylinder with its housing mounted to the transition assembly 106 and its retractable arm mounted to the first attenuator section 102. When the hydraulic arm is extended, it pushes on the first attenuator section to pivot it about the first pivot mount 108 to raise the first attenuator section. While the first attenuator section is being raised, the second attenuator section pivots relative to the first attenuator section about the second pivot mount 110. When the hydraulic arm is fully extended, the first and second attenuator sections are fully raised and stacked as shown in FIG. 13. These steps can be reversed to lower the first and second attenuator sections to their fully extended positions.

In other embodiments, the actuator 112 may be or include an electrically operated cylinder, an electric stepper motor, a pneumatic motor, or any other device that can move the two attenuator sections about the first and second pivot mounts.

In some embodiments, only one actuator 112 pivots both the first and second attenuator sections as described above. In other embodiments, a separate actuator is provided near the second pivot mount to pivot the second attenuator section relative to the first one.

One concern with the above-described pivoting, raising, and folding of the attenuator sections 102, 104 is the potential to allow under-ride during vehicle impacts. Under-ride is where a shorter vehicle, like a small car, tends to push the attenuator section 104 up instead of impacting and longitudinally crushing it is designed. This could be caused by the hinges or other pivot mounts 110 not being strong enough to hold the attenuator sections tight against one another, resulting in the attenuator sections lifting up when they aren't supposed to.

To remove this concern, locking pins controlled by a hydraulic system or electrical motor may be interposed in the pivot mounts 108, 110. Mechanisms such as linear actuators, door poppers, or small rotational motors can drive the movement of the locking pins directly or through a linkage to increase pin throw if needed. The locking pins can be oriented at any angle, depending on the design, to accomplish their purpose. For strength, the pins are supported so that they experience the majority of impact forces instead of directing the forces to the linear actuators, door poppers, rotational motors, etc. that move the pins. This same type of pin mechanism may be used to control the distance between the two attenuator sections when in their folded and stored position to prevent damage and unnecessary movement between the sections.

In addition, in one or more embodiments, a similar pin setup is used to lock the attenuator section 102 to the transition 106 for added security and safety in the event the hydraulics of the actuator 112 fail.

The impact attenuator assembly 100 can be used in substantially the same manner as the impact attenuator assembly 10 described above. The assembly 100 can be attached to the rear of a support vehicle with its backup mount 20. The support vehicle is then driven to or otherwise positioned near a roadway work zone or other area where road repair equipment and/or workers are operating. If struck by an impacting vehicle, the impact attenuator assembly 100 crushes in a coordinated fashion toward the support vehicle to dissipate impact forces from the impacting vehicle. When struck, the support plates are pushed together toward the support vehicle, compressing the energy absorption modules to absorb the impact forces.

Another embodiment of the invention accomplishes the same general folding movement as the impact attenuator assembly 100 described above but adds a cable-pulley system to control movement about pivot mount 110. The overall movement is the same, but a winch motor lets out and takes in a cable attached to the second attenuator section to control its movement relative to the first attenuator section.

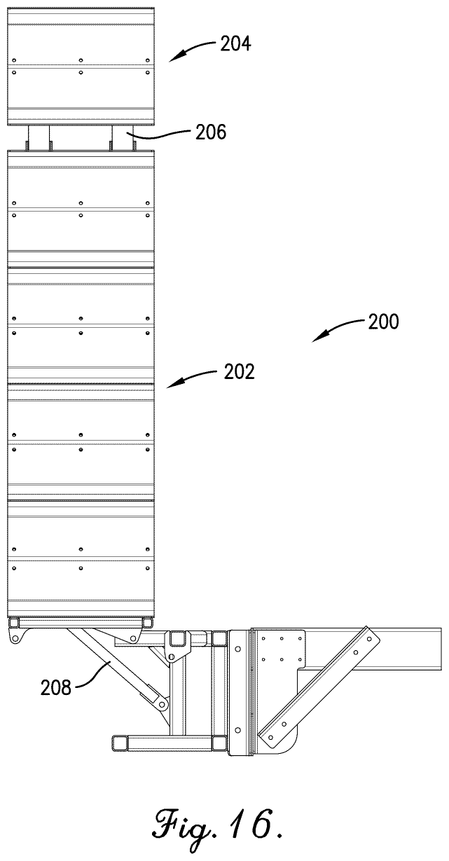

A vehicle-mounted impact attenuator assembly 200 constructed according to another embodiment of the invention is depicted in FIGS. 15 and 16. The impact attenuator assembly 200 includes several attenuator sections 202, 204 attached end-to-end, but instead of a bi-fold design, an extension mechanism 206 shifts the end section 204 between an extended, deployed position shown in FIG. 15 and a retracted position shown in FIG. 16. An actuator and linkage mechanism 208, which may include a hydraulic cylinder, electrically operated actuator, an electric stepper motor, a pneumatic actuator, or any other device than can move the attenuator sections relative to one another, lifts the first attenuator section 202 relative to the support vehicle. As the first attenuator section 202 is pivoted up into its stored position, the linkage mechanism 208 pulls the second attenuator section 204 towards the section 202. Conversely, As the first attenuator section 202 is pivoted down to its extended position, the linkage mechanism 208 pushes the second attenuator section 204 away from the section 202.

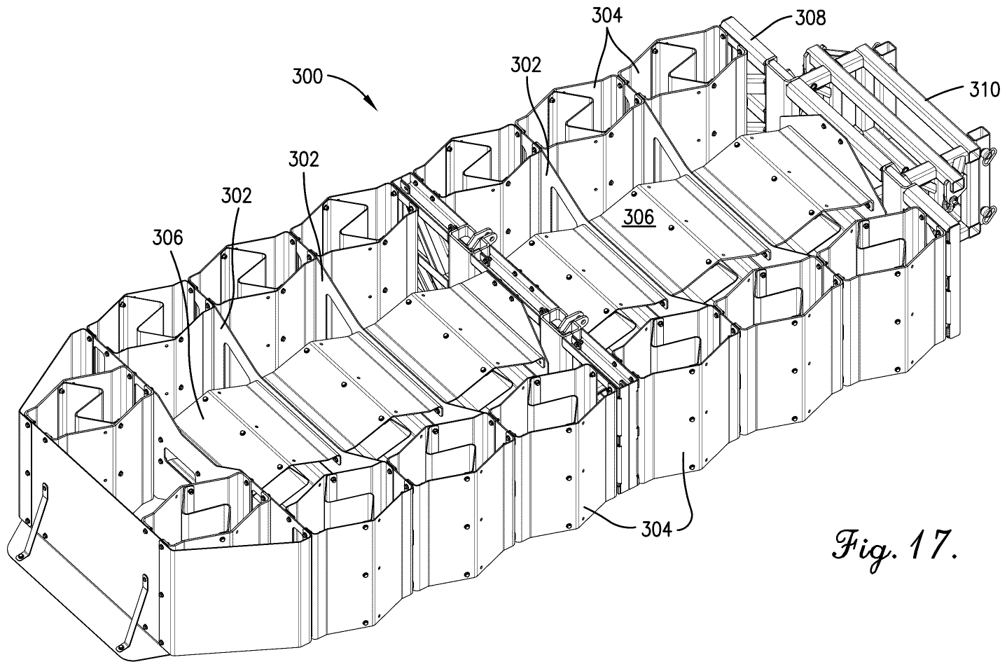

A vehicle-mounted impact attenuator assembly 300 constructed according to another embodiment of the invention is shown in FIG. 17 and includes a plurality of support plates 302; a plurality of energy absorption modules 304, 306 sandwiched between and attached to the support plates 302; a backup mount 308; and a transition assembly 310 that supports an actuator system (not shown in FIG. 17) and that attaches the backup mount to a support vehicle.

The support plates 302 and backup mount 308 are substantially the same as the support plates and backup mount described above and therefore won't be described again.

The energy absorption modules comprise vertically extending energy absorption modules 304 and horizontally extending energy absorption modules 306. In one embodiment, one horizontally extending energy absorption module 306 is positioned between each pair of spaced-apart vertically extending energy absorption modules 304.

The vertically-extending energy absorption modules 304 are substantially identical to the energy absorption modules 16A shown in FIGS. 7 and therefore won't be described again. Other embodiments of the modules 304 may be similar to the modules 16 shown in FIG. 5 or the modules 16B show in FIG. 8. The horizontally-extending energy absorption modules 306 are also similar to the energy absorption modules 16A shown in FIG. 7 except that they are oriented horizontally rather than vertically. Other embodiments of the modules 306 may be similar to the modules 16 shown in FIG. 5 or the modules 16B show in FIG. 8.

The impact attenuator assembly 300 can be used in substantially the same manner as the impact attenuator assembly 10 described above. The assembly 300 can be attached to the rear of a support vehicle with its backup mount. The support vehicle is then driven to or otherwise positioned near a roadway work zone or other area where road repair equipment and/or workers are operating. If struck by an impacting vehicle, the impact attenuator assembly 300 crushes in a coordinated fashion toward the support vehicle to dissipate impact forces from the impacting vehicle. When struck, the support plates are pushed together toward the support vehicle, compressing the energy absorption modules to absorb the impact forces.

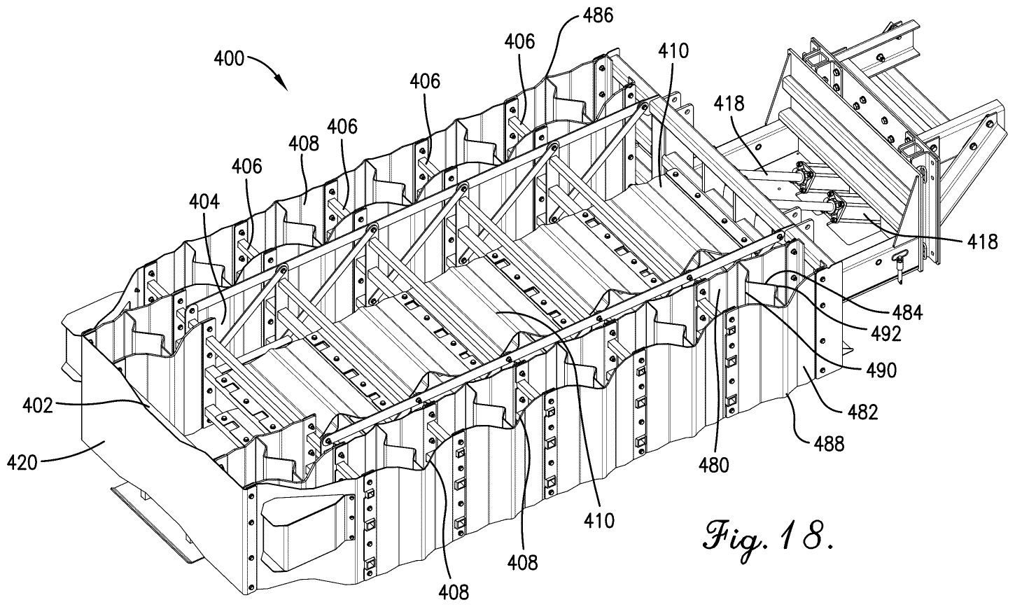

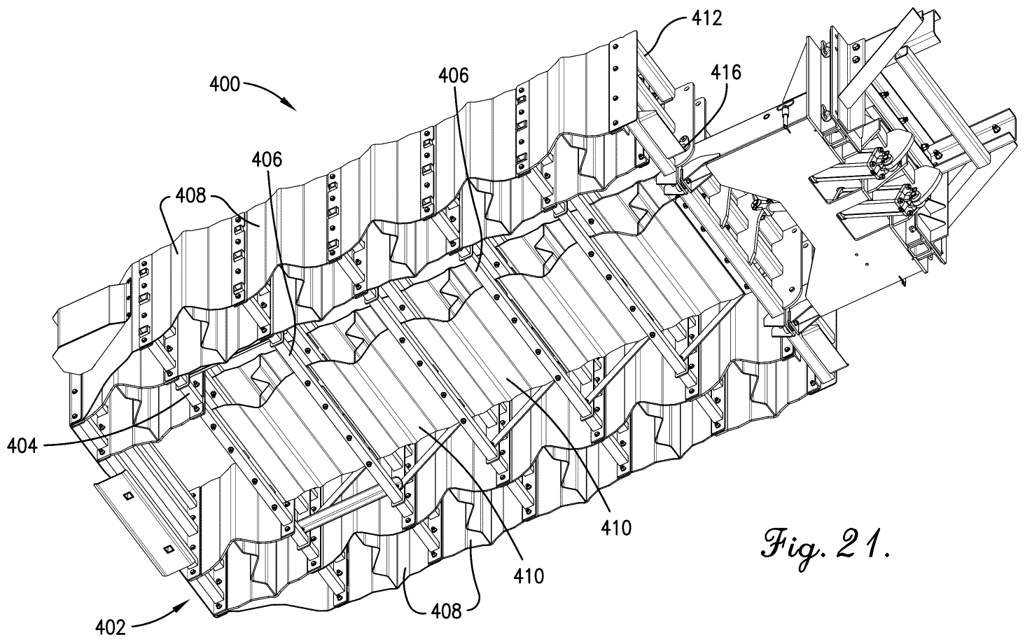

A vehicle-mounted impact attenuator assembly 400 constructed according to another embodiment of the invention is depicted in FIGS. 18-25 and comprises a plurality of longitudinally spaced bulkheads 402, 404, 406; at least one vertically-extending energy absorption module 408 and at least one horizontally-extending energy absorption module 410 sandwiched between the bulkheads; a backup mount 412 for mounting the attenuator assembly to a support vehicle; a transition assembly 414; a pivot mount 416 for pivotally connecting the backup mount to the transition assembly and thus to the support vehicle; and a pair of actuators 418 for pivoting the attenuator assembly about the pivot mount.

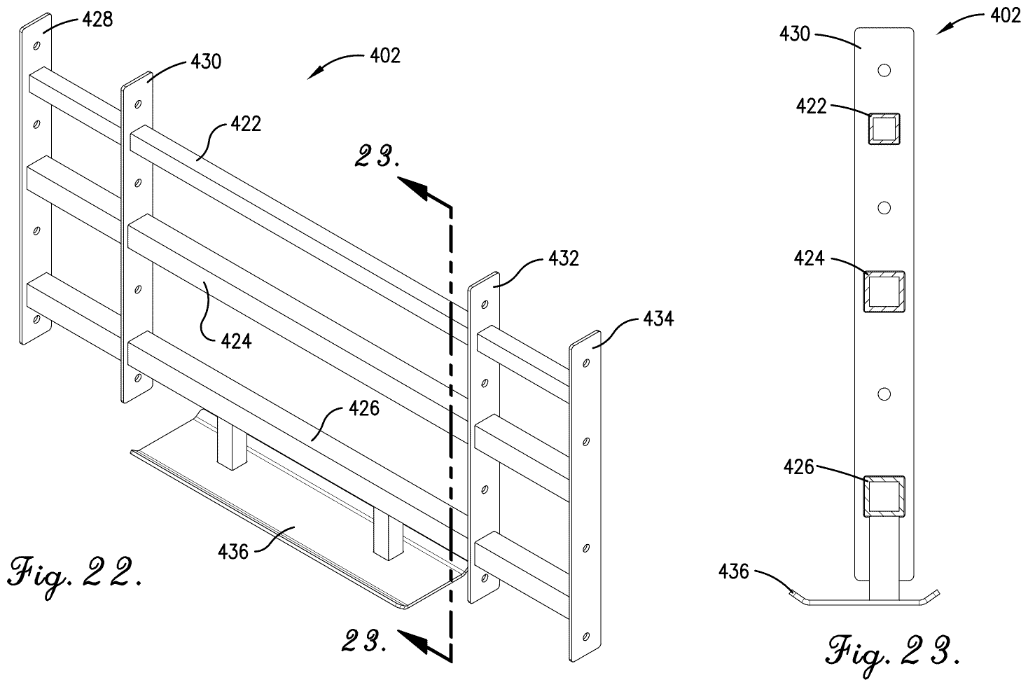

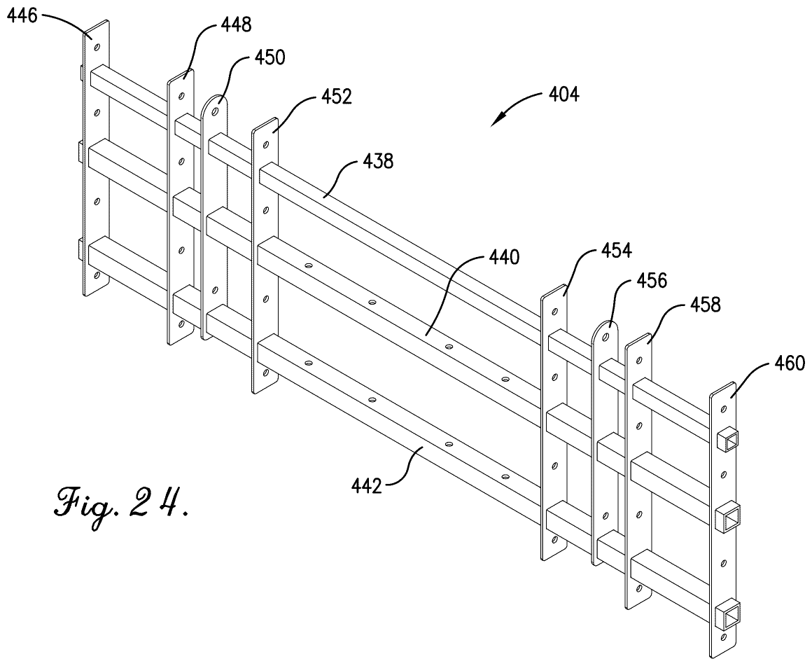

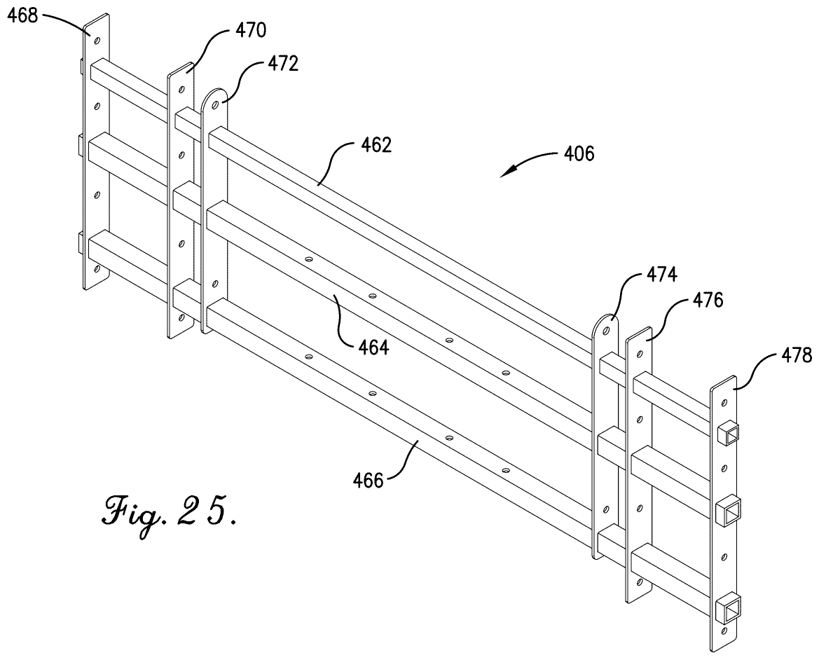

The bulkheads 402, 404, 406 support the energy absorption modules and include a nose bulkhead 402 shown in FIGS. 22 and 23; a front bulkhead 404 shown in FIG. 24; and a number of rear bulkheads 406 shown in FIG. 25. The components of the bulkheads 402, 404, 406 may be formed of steel or other rigid materials.

The nose bulkhead 402 supports a nose impact plate 420 and two of the energy absorption modules 408 at the impact end of the attenuator assembly. As shown in FIGS. 22 and 23, an embodiment of the nose bulkhead 402 includes horizontally extending top, middle, and bottom tubes 422, 424, 426; vertically extending mounting flanges 428, 430, 432, 434 that are horizontally spaced on the tubes; and a ground-engaging skid plate 436.

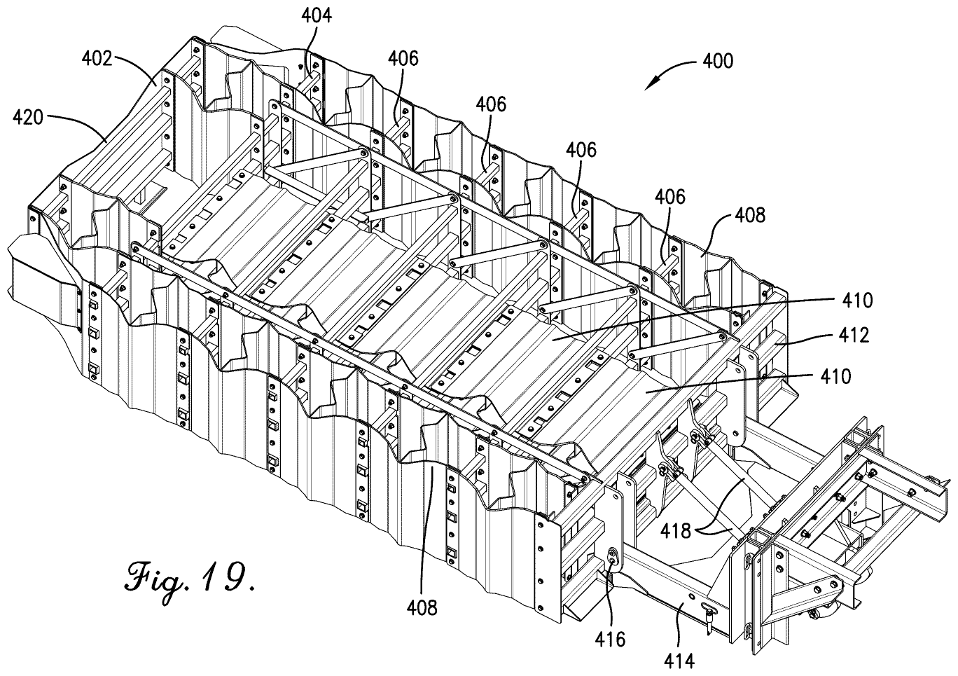

In one embodiment, the tubes 422, 424, 426 pass through notches formed in the flanges 428, 430, 432, 434. Alternatively, the tubes and flanges may also be welded, bolted, or otherwise connected together. The tubes and flanges support the front end of a pair of the energy absorption modules as best shown in FIG. 19

The ground-engaging skid plate 436 extends from the bottom tube 426 and prevents the nose plate 420 and other components of the attenuator assembly from contacting the ground during impacts. This prevents an impacting vehicle from pushing the nose plate down to the ground and thus facilitates crushing of the attenuator assembly while minimizing snagging on unlevel or damaged roadway surfaces. The skid plate 436 also provides a contact point with the underside of an impacting vehicle to limit upward movement of the attenuator assembly and to thus prevent an impact vehicle from going under the attenuator assembly.

The front bulkhead 404 supports the energy absorption modules near the front of the attenuator assembly and includes horizontally extending top, middle, and bottom tubes 438, 440, 442; and vertically extending mounting flanges 446, 448, 450, 452, 454, 456, 458, and 460 that are horizontally spaced on the tubes. In one embodiment, the tubes pass through notches formed in the flanges. Alternatively, they may be welded or bolted together. The tubes and flanges support a row of the energy absorption modules as best shown in FIG. 19.

The rear bulkheads 406 support energy absorption modules near the middle and support vehicle end of the attenuator assembly and also include horizontally extending top, middle, and bottom tubes 462, 464, 466; and vertically extending mounting flanges 468, 470, 472, 474, 476, 478 that are horizontally spaced on the tubes. In one embodiment, the tubes pass through notches formed in the flanges. Alternatively, they may also be welded or bolted together. Each rear bulkhead supports one row of the energy absorption modules as best shown in FIG. 19.

The energy absorption modules comprise vertically extending energy absorption modules 408 and horizontally extending energy absorption modules 410. The vertically extending energy absorption modules are positioned on the sides of the attenuator assembly such that two of them sandwich each horizontally-extending energy absorption module.

The vertically-extending energy absorption modules 408 are similar to the energy absorption modules 16A shown in FIGS. 7. The horizontally-extending energy absorption modules 410 are also similar to the energy absorption modules 16A shown in FIG. 7 except that they are oriented horizontally rather than vertically.

As labeled in FIG. 18, each of the vertically-extending energy absorption modules 408 includes first and second longitudinally extending plates 480, 482 and a laterally extending plate 484. The plates may be formed of aluminum sheet metal or other suitable rigid materials. The overall length, lengths between bends, bend angles, material thickness, material type, and connection can be modified to obtain the desired overall force resistance and behavior.

The longitudinally extending plates 480, 482 extend generally parallel to the longitudinal axis of the attenuator assembly and include notches through which the tubes of the bulkheads extend. The ends of the plates are bolted, welded, or otherwise fastened to the mounting flanges of the bulkheads. The longitudinally extending plates also include opposing outwardly protruding hinge sections 486, 488.

The laterally extending plate 484 is positioned between and welded to or otherwise attached near the mid-point of each longitudinally extending plate. Each laterally extending plate has a pair of hinge sections 490, 492.

The horizontally extending energy absorption modules are positioned in the middle of the attenuator assembly between pairs of the vertically extending energy absorption modules. The horizontally-extending energy absorption modules are basically the same as the vertically extending energy absorption modules except they are offset by 90 degrees.

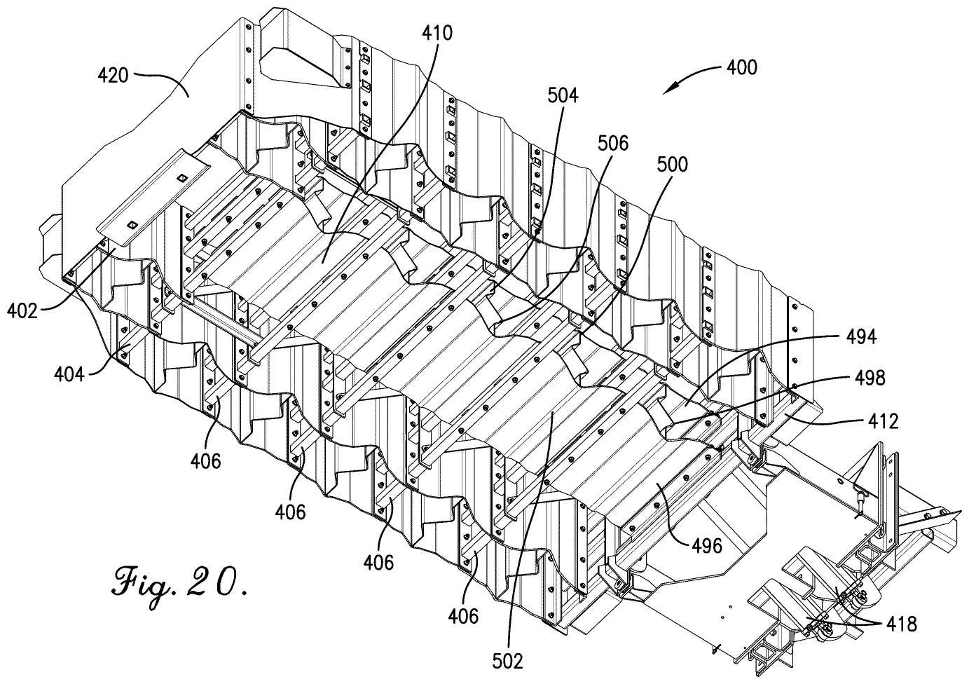

As labeled in FIG. 20, each horizontally extending energy absorption module 410 includes first and second longitudinally extending plates 494, 496 and a laterally extending plate 498. The plates may be formed of aluminum sheet metal or other suitable rigid materials. The overall length, lengths between bends, bend angles, material thickness, material type, and connection can be modified to obtain the desired overall force resistance and behavior.

The longitudinally extending plates extend generally parallel to the longitudinal axis of the attenuator assembly. One of the plates is bolted or otherwise attached to the lower tubes of adjacent bulkheads and the other is bolted or otherwise attached to the middle tubes of adjacent bulkheads. The longitudinally extending plates include opposing outwardly protruding hinge sections 500, 502.

The laterally extending plate is positioned between and welded to or otherwise attached near the mid-point of each longitudinally extending plate. Each laterally extending plate has a pair of hinge sections 504, 506.

The transition assembly 414 spaces the attenuator assembly from the support vehicle so that it may be moved relative to the support vehicle and provides a mounting location for the actuators. The transition assembly has a horizontal bar to absorb impact forces and distribute them evenly across the width of the transition assembly. This shields the actuators from damage during impacts.

The pivot mount 416 pivotally connects the attenuator assembly to the transition assembly and thus to the support vehicle. The actuators 418 pivot the attenuator assembly about the pivot mount to raise and stack the attenuator assembly for easier transport and storage.

The pivot mount 416 may comprise a sleeve bearing and pivot pin or any other hinge mechanism that allows the attenuator to be pivoted relative to the transition assembly.

The actuators 418 pivot the attenuator about the pivot mount to shift the impact attenuator assembly between its fully extended position or state shown in FIGS. 18-21 and its raised and folded position. In one embodiment, the actuators are hydraulic cylinders with their housings mounted to the transition assembly and their retractable arms mounted to the backplate 412 of the attenuator. When the hydraulic arms are extended, they push on the attenuator to pivot it about the pivot mount to raise it. These steps can be reversed to lower the attenuator sections to its fully extended position.

In other embodiments, the actuators may be or include electrically operated cylinders, electric stepper motors, pneumatic actuators, or any other devices that can move the attenuator sections about the pivot mount.

The impact attenuator assembly 400 can be used in substantially the same manner as the impact attenuator assembly 10 described above. The assembly 400 can be attached to the rear of a support vehicle with its backup mount. The support vehicle is then driven to or otherwise positioned near a roadway work zone or other area where road repair equipment and/or workers are operating. If struck by an impacting vehicle, the impact attenuator assembly 400 crushes in a coordinated fashion toward the support vehicle to dissipate impact forces from the impacting vehicle. When struck, the bulkheads are pushed together toward the support vehicle, compressing the energy absorption modules to absorb the impact forces.

The present invention is not limited to the above-described embodiments of impact attenuator assemblies. Other embodiments of impact attenuator assemblies may be configured with varying materials, material thicknesses, heights, bend radii, bend angles, numbers of bends, numbers of energy absorption modules, and with different impact noses without departing from the scope of the present invention. In one embodiment, the impact nose or plate may be formed of polymer materials and the remainder of the attenuator formed of sheet metal. Multiple configurations of energy absorption modules can be combined in a single attenuator assembly, or a single embodiment of an energy absorption module can be used throughout the attenuator assembly, depending on the desired energy absorbing characteristics.

### ADDITIONAL CONSIDERATIONS

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claims set forth in any subsequent regular utility patent application. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the drawing figures, it is noted that equivalents may be employed and substitutions made herein without departing from the scope of the invention as recited in the claims.

1. A vehicle-mounted impact attenuator assembly comprising:
a first attenuator section configured to be mounted to a support vehicle;
a second attenuator section forming an impact side of the impact attenuator assembly;
a first pivot mount pivotally connecting the first attenuator section to the support vehicle;
a second pivot mount pivotally connecting the second attenuator section to the first attenuator section; and
an actuator for pivoting the first attenuator section about the first pivot mount and pivoting the second attenuator section about the second pivot mount to raise and stack the first attenuator section and the second attenuator section for easier transport and storage.

2. The vehicle-mounted impact attenuator assembly of claim 1, further comprising a mount for supporting the first attenuator section to the support vehicle.

3. The vehicle-mounted impact attenuator assembly of claim 2, wherein the actuator comprises a hydraulic cylinder attached between the first attenuator section and the mount.

4. The vehicle-mounted impact attenuator assembly of claim 2, further comprising an actuator pivotally connected between the first and second attenuator sections and configured to shift the second attenuator section relative to the first attenuator cartridge.

5. The vehicle-mounted impact attenuator assembly of claim 2, further comprising a pulley system configured to shift the second attenuator section relative to the first attenuator section.

6. The vehicle-mounted impact attenuator assembly of claim 2, wherein the first and second attenuator sections each comprise:
a plurality of support plates spaced along a longitudinal axis; and
a plurality of energy absorption modules sandwiched between the support plates, each energy absorption module comprising:
first and second longitudinally extending plates positioned between a pair of the support plates, each of the first and second longitudinally extending plates having a hinge section; and
a first laterally extending plate positioned between and attached to the first and second longitudinally extending plates, the first laterally extending plate having a hinge section.

7. A vehicle-mounted impact attenuator assembly comprising:
a first attenuator section configured to be mounted to a support vehicle;
a mount for supporting the first attenuator section to the support vehicle;
a second attenuator section forming an impact side of the impact attenuator assembly;
a first pivot mount coupled with the first attenuator section and the mount for pivotally connecting the first attenuator section to the mount;
a second pivot mount pivotally connecting the second attenuator section to the first attenuator section; and
an actuator for pivoting the first attenuator section about the first pivot mount to raise the first attenuator section for easier transport and storage.

8. The vehicle-mounted impact attenuator assembly of claim 7, wherein the actuator is further operable for pivoting the second attenuator section about the second pivot mount to raise and stack the second attenuator section against the first attenuator section for easier transport and storage.

9. The vehicle-mounted impact attenuator assembly of claim 7, further comprising a second actuator for pivoting the second attenuator section about the second pivot mount to raise and stack the second attenuator section against the first attenuator section for easier transport and storage.

10. The vehicle-mounted impact attenuator assembly of claim 7, wherein the actuator comprises a hydraulic cylinder attached between the first attenuator section and the mount.

11. The vehicle-mounted impact attenuator assembly of claim 7, wherein the second actuator comprises a hydraulic cylinder attached between the first attenuator section and the second attenuator section.

12. The vehicle-mounted impact attenuator assembly of claim 7, wherein the second actuator comprises a linkage mechanism between the first attenuator section and the second attenuator section.

13. The vehicle-mounted impact attenuator assembly of claim 7, wherein the second actuator comprises a pulley system configured to shift the second attenuator section relative to the first attenuator section.

14. The vehicle-mounted impact attenuator assembly of claim 1, wherein the first and second attenuator sections each comprise:
a plurality of support plates spaced along a longitudinal axis; and
a plurality of energy absorption modules sandwiched between the support plates, each energy absorption module comprising:
first and second longitudinally extending plates positioned between a pair of the support plates, each of the first and second longitudinally extending plates having a hinge section; and
a first laterally extending plate positioned between and attached to the first and second longitudinally extending plates, the first laterally extending plate having a hinge section.

15. A vehicle-mounted impact attenuator assembly comprising:
a first attenuator section configured to be mounted to a support vehicle;
a mount for supporting the first attenuator section to the support vehicle;
a second attenuator section forming an impact side of the impact attenuator assembly;
a first pivot mount coupled with the first attenuator section and the mount for pivotally connecting the first attenuator section to the mount;
an extension assembly for connecting the second attenuator section to the first attenuator section;
a first actuator for pivoting the first attenuator section about the first pivot mount to raise the first attenuator section for easier transport and storage;
a second actuator for operating the extension assembly to extend or retract the second attenuator section relative to the first attenuator section.

16. The vehicle-mounted impact attenuator assembly of claim 15, wherein the first actuator comprises a hydraulic cylinder attached between the first attenuator section and the mount.

17. The vehicle-mounted impact attenuator assembly of claim 15, wherein the second actuator comprises a hydraulic cylinder attached to the extension mechanism.

18. The vehicle-mounted impact attenuator assembly of claim 15, wherein the extension mechanism comprises a linkage mechanism between the first attenuator section and the second attenuator section.

19. The vehicle-mounted impact attenuator assembly of claim 15, wherein the second actuator comprises a pulley system configured to extend or retract the second attenuator section relative to the first attenuator section.

20. The vehicle-mounted impact attenuator assembly of claim 15, wherein the first and second attenuator sections each comprise:
a plurality of support plates spaced along a longitudinal axis; and
a plurality of energy absorption modules sandwiched between the support plates, each energy absorption module comprising:
first and second longitudinally extending plates positioned between a pair of the support plates, each of the first and second longitudinally extending plates having a hinge section; and
a first laterally extending plate positioned between and attached to the first and second longitudinally extending plates, the first laterally extending plate having a hinge section.
